(19) United States
(12) Patent Application Publication
(10) Pub. No.: US 2015/0228046 A1
(43) Pub. Date: Aug. 13, 2015

(54) AUTOMATICALLY PERFORMING A TRADE-OFF BETWEEN VISUAL QUALITY AND LATENCY DURING RENDERING OF A VIDEO/GRAPHICS SEQUENCE

(71) Applicant: NVIDIA Corporation, Santa Clara, CA (US)

(72) Inventors: Darshan Uppinkere, Pune (IN); Jithin Thomas, Pune (IN); Ravi Kandala, Pune (IN)

(73) Assignee: NVIDIA Corporation, Santa Clara, CA (US)

(21) Appl. No.: 14/178,330

(22) Filed: Feb. 12, 2014

(51) Int. Cl. G06T 1/20

(52) U.S. Cl. CPC G06T 1/20

(57) ABSTRACT

A method includes automatically capturing, through a processor of a data processing device communicatively coupled to a memory, one or more parameter(s) related to a visual quality of rendering of a video frame that is part of a sequence on a display unit communicatively coupled to the processor and one or more parameter(s) related to latency associated with the rendering of the video frame on the display unit. The sequence is a video and/or a graphics sequence. The method also includes performing, through the processor, an automatic trade-off between the one or more parameter(s) related to the visual quality and the one or more parameter(s) related to the latency to maintain the one or more parameter(s) related to the visual quality or the one or more parameter(s) related to the latency within a threshold during the rendering of the video frame.

### FIELD OF TECHNOLOGY

This disclosure relates generally to data processing devices and, more particularly, to a method, a device and/or a system for automatically performing a trade-off between visual quality and latency during rendering of a video/graphics sequence.

### BACKGROUND

A gaming experience on a data processing device (e.g., a personal computer, a tablet, a gaming console) including a processor (e.g., Central Processing Unit (CPU), Graphics Processing Unit (GPU)) may involve a scenario where a load on the processor may be large enough for the processor to not be able to push video frames out to be rendered on a display unit at a constant rate. The video frame rate, therefore, may drop. This may prove detrimental to the gaming experience of a user of the data processing device especially when he/she is unable to respond to an action effected through another data processing device that is also part of the “multi-player” gaming experience due to the extended processing through the processor.

The user may opt to clock the processor at a higher rate to increase the frame rate if enough thermal/power headroom is available. However, this may lead to increased power consumption through the data processing device.

### SUMMARY

Disclosed are a method, a device and/or a system for automatically performing a trade-off between visual quality and latency during rendering of a video/graphics sequence.

In one aspect, a method includes automatically capturing, through a processor of a data processing device communicatively coupled to a memory, one or more parameter(s) related to a visual quality of rendering of a video frame that is part of a sequence on a display unit communicatively coupled to the processor and one or more parameter(s) related to latency associated with the rendering of the video frame on the display unit. The sequence is a video and/or a graphics sequence. The method also includes performing, through the processor, an automatic trade-off between the one or more parameter(s) related to the visual quality and the one or more parameter(s) related to the latency to maintain the one or more parameter(s) related to the visual quality or the one or more parameter(s) related to the latency within a threshold during the rendering of the video frame.

In another aspect, a non-transitory medium, readable through a data processing device and including instructions embodied therein that are executable through the data processing device, is disclosed. The non-transitory medium includes instructions to automatically capture, through a processor of the data processing device communicatively coupled to a memory, one or more parameter(s) related to a visual quality of rendering of a video frame that is part of a sequence on a display unit communicatively coupled to the processor and one or more parameter(s) related to latency associated with the rendering of the video frame on the display unit. The sequence is a video and/or a graphics sequence. The non-transitory medium also includes instructions to perform, through the processor, an automatic trade-off between the one or more parameter(s) related to the visual quality and the one or more parameter(s) related to the latency to maintain the one or more parameter(s) related to the visual quality or the one or more parameter(s) related to the latency within a threshold during the rendering of the video frame.

In yet another aspect, a data processing device includes a memory and a processor communicatively coupled to the memory. The processor is configured to execute instructions to automatically capture one or more parameter(s) related to a visual quality of rendering of a video frame that is part of a sequence on a display unit communicatively coupled to the processor and one or more parameter(s) related to latency associated with the rendering of the video frame on the display unit. The sequence is a video and/or a graphics sequence. The processor is also configured to execute instructions to perform an automatic trade-off between the one or more parameter(s) related to the visual quality and the one or more parameter(s) related to the latency to maintain the one or more parameter(s) related to the visual quality or the one or more parameter(s) related to the latency within a threshold during the rendering of the video frame.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a content delivery system, according to one or more embodiments.

FIG. 2 is a schematic view of a user interface associated with a multimedia application and/or an operating system executing on a client device of the content delivery system of FIG. 1, according to one or more embodiments.

FIG. 3 is a schematic view of interaction between a driver component and a processor of the client device of FIG. 1, according to one or more embodiments.

FIG. 4 is a flowchart detailing the operations involved in maintenance of frame rate during rendering of a video/graphics sequence in the client device of the content delivery system of FIG. 1, according to one or more embodiments.

FIG. 5 is a process flow diagram detailing the operations involved in automatically performing a trade-off between visual quality and latency during rendering of a video/graphics sequence in the client device of the content delivery system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device for automatically performing a trade-off between visual quality and latency during rendering of a video/graphics sequence. Although the present embodiments have been described with reference to specific example embodiments, it will be evident that various modifications and changes may be made to these embodiments without departing from the broader spirit and scope of the various embodiments.

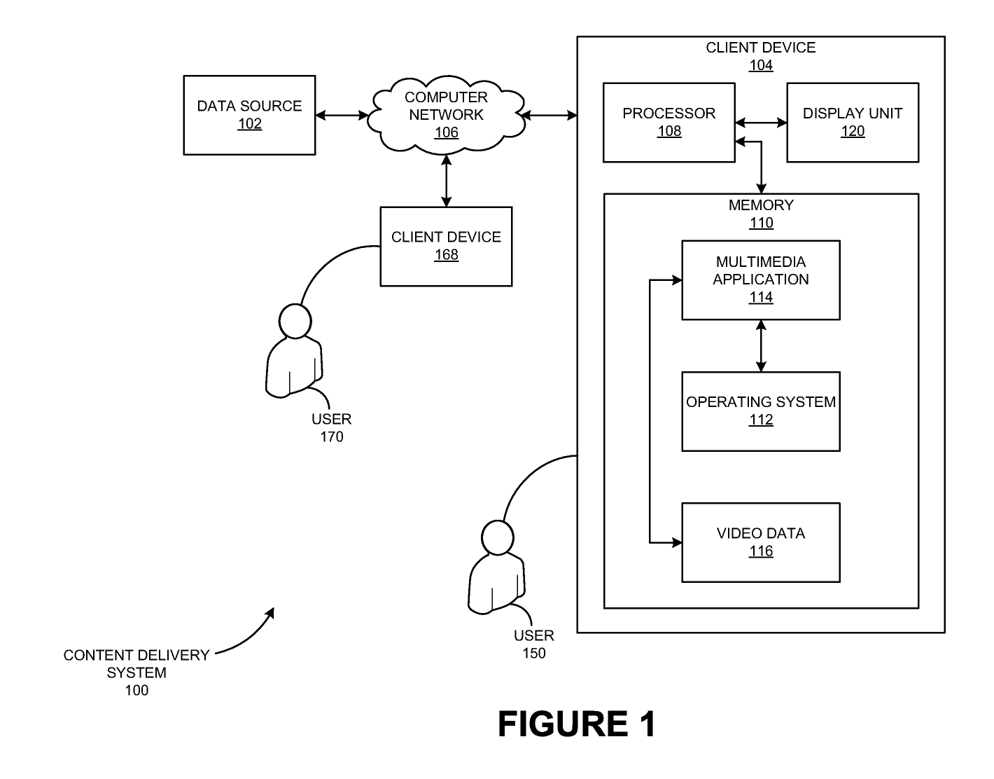

FIG. 1 shows a content delivery system 100, according to one or more embodiments. In one or more embodiments, content delivery system 100 may include a data source 102 (e.g., a server, a computing device) communicatively coupled to one or more client device(s) (e.g., client device 104, client device 168 to be discussed below) through a computer network 106 (e.g., Internet, Local Area Network (LAN), Wide Area Network (WAN)). In one or more embodiments, data source 102 may be a server configured to generate real-time data, encode the aforementioned real-time data as video/image data and transmit the video/image data to client device 104 (and client device 168) through computer network 106. For example, content delivery system 100 may be a cloud-gaming environment or a video-conferencing environment.

It should be noted that content delivery system 100 may not be limited to the cloud-gaming environment or video-conferencing environment mentioned above. For example, data source 102 may also be a mere personal computer transmitting data wirelessly (e.g., through Wi-Fi®) to a tablet (an example client device 104) coupled to a television (for display purposes) through a High-Definition Multimedia Interface (HDMI) cable. Further, content delivery system 100 may not be limited to data transmission through computer network 106. For example, concepts discussed herein may also be applicable to processing associated with files locally stored on, say, client device 104. All example data processing systems having the capability to incorporate concepts discussed herein therein are within the scope of the exemplary embodiments.

In typical solutions, video frames/images may be received at client device 104, following which a decoder thereat decodes the video frames/images. FIG. 1 shows client device 104 as including a processor 108 communicatively coupled to a memory 110. In one or more embodiments, processor 108 may be a Central Processing Unit (CPU), a Graphics Processing Unit (GPU) and/or any dedicated processor configured to execute an appropriate decoding engine thereon (decoding engine may instead be hardware); the dedicated processor may, alternately, be configured to control the appropriate decoding engine executing on another processor. All variations therein are within the scope of the exemplary embodiments. In one or more embodiments, memory 110 may be a volatile memory and/or a non-volatile memory.

It is obvious that an operating system 112 may execute on client device 104. FIG. 1 shows operating system 112 as being stored in memory 110 (e.g., non-volatile memory). In one or more embodiments, client device 104 may execute a multimedia application 114 (e.g., a media/multimedia player, a gaming application) on processor 108; multimedia application 114 may be configured to render video/image data as a stream on an interface thereon. FIG. 1 shows multimedia application 114 as being stored in memory 110 to be executed on processor 108. FIG. 1 also shows video data 116 (and/or graphics data) to be streamed/rendered through multimedia application 114 as also being resident in memory 110 (e.g., volatile memory).

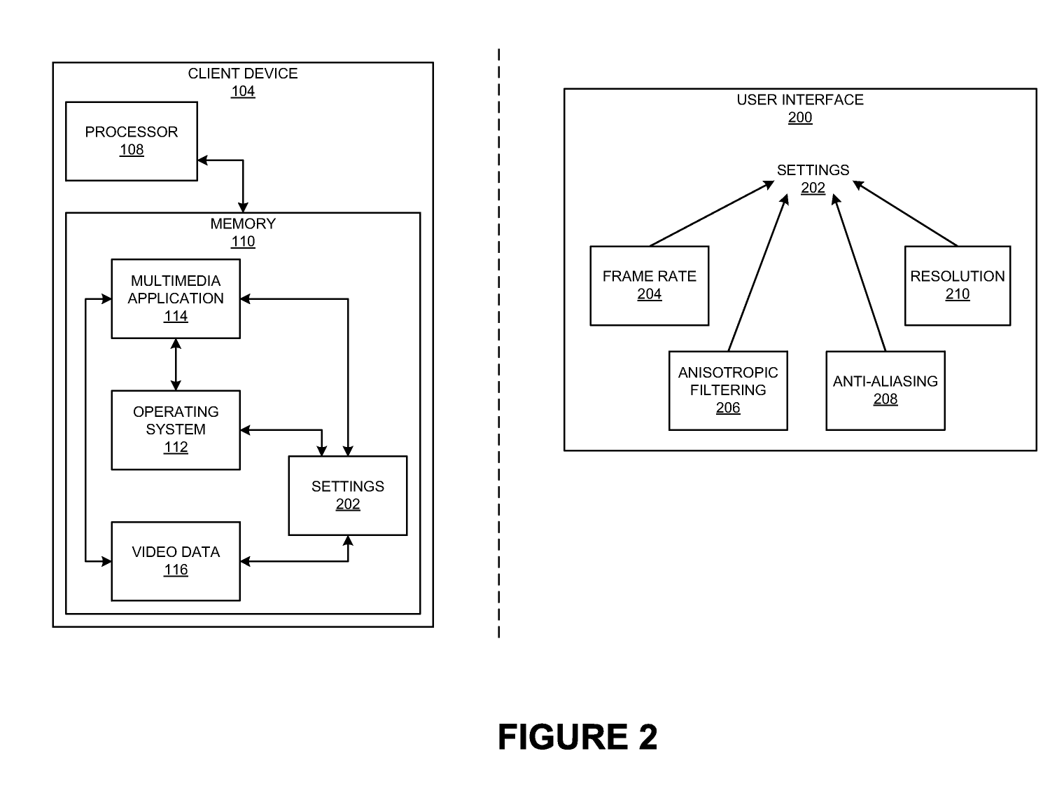

In one or more embodiments, output data associated with processing through processor 108 may be rendered on a display unit 120 (e.g., Liquid Crystal Display (LCD) display, Light Emitting Diode (LED) display, Cathode Ray Tube (CRT) monitor); FIG. 1 shows display unit 120 interfaced with processor 108. FIG. 2 shows providing a capability to a user 150 of client device 104 to configure settings 202 (e.g., graphics settings, video settings) associated with multimedia application 114 and/or video data 116 (and/or graphics data) through a user interface 200 associated with multimedia application 114 and/or operating system 112. Example graphics/video settings 202 that may be configured include but are not limited to frame rate 204, anisotropic filtering 206 as especially applied to computer graphics, anti-aliasing 208 and resolution 210. FIG. 2 also shows settings 204 as being associated with operating system 112.

In the case of a multi-player gaming scenario (example multimedia application 114), there may be another client device 168 analogous to client device 104; FIG. 1 shows client device 168 communicably interfaced with data source 102 and client device 104 through computer network 106. User 150 of client device 104 may fiddle with settings 202 such as anisotropic filtering 206 and resolution 210 prior to launching a game through client device 104. As discussed above, settings 202 may be modified through, for example, user interface 200 associated with multimedia application 114; also, the game may then be played through clicking a “LAUNCH” (not shown) button thereon. User 150 may continue fiddling with the aforementioned settings 202 until he/she gets a satisfactory frame rate 204 (e.g., 60 fps, 45 fps) during the course of the gaming experience. In essence, user 150 may attempt an optimization process between frame rate 204 and visual quality. Alternately, frame rate 204 may possess a default value thereof.

It should be noted that “frame rate” within the context of gaming may refer to a rate at which an image/video frame is refreshed; in other words, frame rate may be expressed in images/video frames per second. Now, if user 150 is satisfied with frame rate 204 (e.g., as seen through a preview of a gaming experience, as seen through a trial run of a game) obtained after fiddling with settings 202, he/she may follow a course of the gaming experience. During the course of the gaming experience, there may occur a scenario where a load on processor 108 may be excessive such that processor 108 may take a longer time than usual to process video frames/graphics/images. This may, for example, occur when there is an explosion scene as part of the gaming experience.

The explosion scene being rendered on display unit 120 may have a number of video frames/images (part of a video sequence) associated therewith. Processor 108, therefore, may expend a considerable amount of time in processing/decoding said number of video frames/images and rendering thereof. Therefore, processor 108 may be unable to transmit/render video frames/images at a constant frame rate 204. This may cause frame rate 204 to drop. If another scenario immediately occurs following the explosion, user 150 may be unable to immediately respond thereto owing to the drop in frame rate 204.

For example, a virtual representation of a character in the game associated with user 150 may be under constant attack from another virtual representation of an enemy character associated with another user 170 at client device 168 (client device 168 and client device 104 may be remote from one another). The constant attack may render it impossible for user 150 to respond (e.g., by refreshing “lives” of the virtual representation following an explosion in which the virtual representation “dies”) through client device 104 because there may be a time delay between the explosion “on screen” on display unit 120 and a new interface presented thereon (e.g., through multimedia application 114) to user 150 to respond to the explosion.

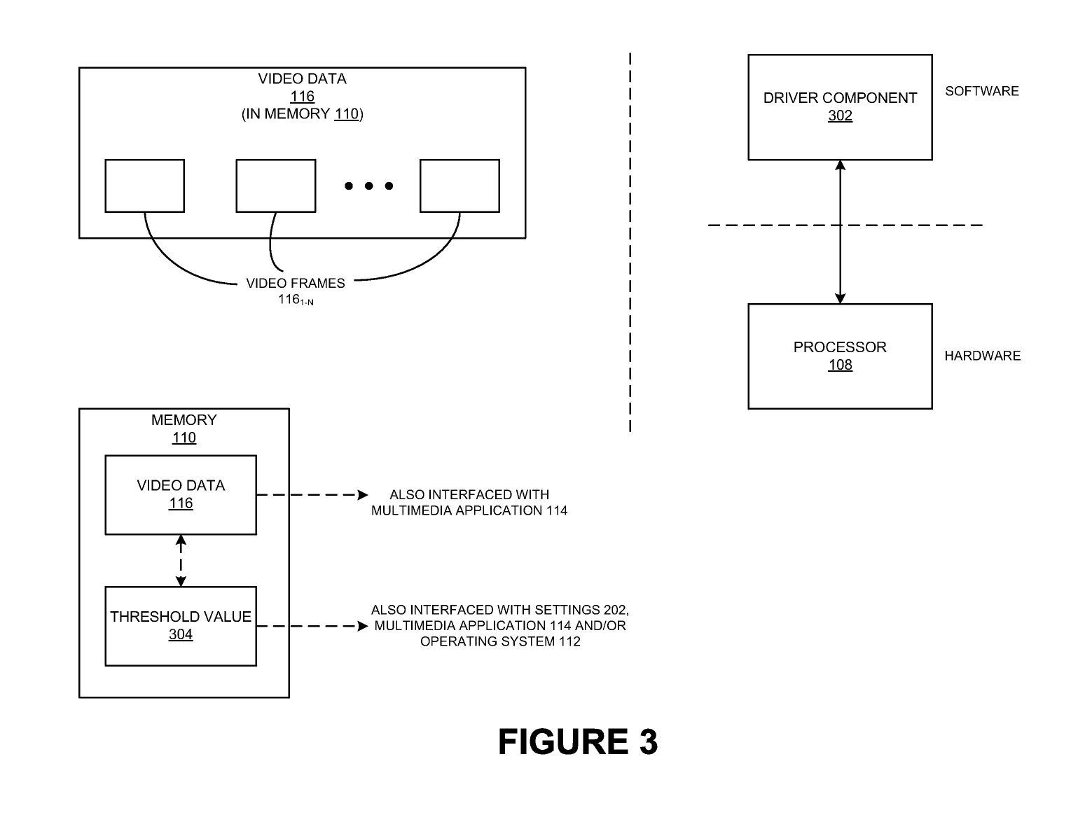

FIG. 3 shows video data 116 as including a number of video frames 116_{1-N} that are part of a video sequence. In one or more embodiments, the aforementioned mentioned video frames 116_{1-N} may be decoded through processor 108 prior to being rendered on display unit 120. FIG. 3 also shows interaction between a driver component 302 and processor 108, according to one or more embodiments. In one or more embodiments, driver component 302 may be configured to trigger capturing, through processor 108, a time taken to render a video frame 116_{1-N}; the aforementioned capturing may occur during the course (e.g., as a background process) of the gaming experience of user 150. In one or more embodiments, if the time taken to render video frame 116_{1-N} exceeds a threshold value 304 (e.g., stored in memory 110), processor 108 may be configured to effect a modification (e.g., again, may be triggered through driver component 302) of settings 202 such that the time taken to render video frame 116_{1-N} is less than or equal to threshold value 304.

Assuming an operating frame rate 204 of 60 frames per second (fps), the ideal time (TI) taken to render video frame 116_{1-N} may be 1/60 seconds. The actual time taken (TTR) to render video frame 116_{1-N} may be captured through processor 108. If TTR is determined to be greater than TI, then one or more setting(s) 202 (other than frame rate 204) may be modified such that TTR falls within TI. In other words, one or more setting(s) 202 may be appropriately modified such that frame rate 204 is maintained.

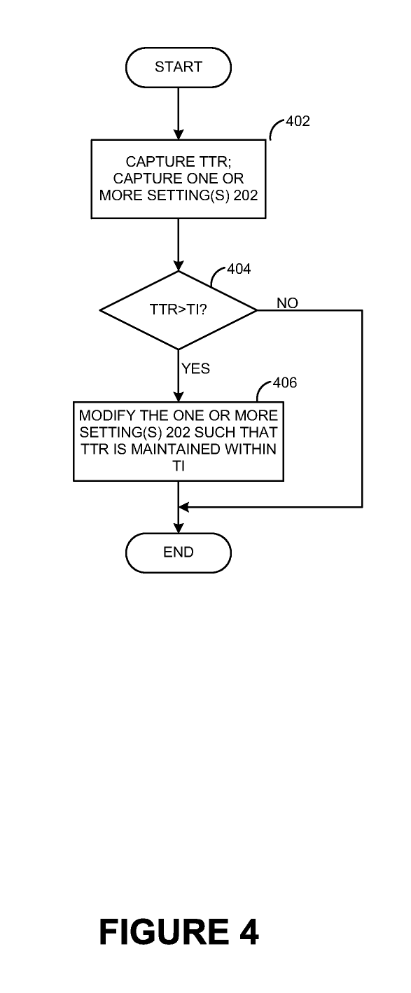

FIG. 4 shows a flowchart detailing the operations involved in the abovementioned maintenance of frame rate 204, according to one or more embodiments. In one or more embodiments, operation 402 may involve capturing, through processor 108, TTR discussed above; operation 402 may also involve capturing, through processor 108, one or more setting(s) 202 discussed above. In one or more embodiments, operation 404 may involve checking, through processor 108, as to whether TTR>TI. In one or more embodiments, if yes, operation 406 may then involve modifying, through processor 108, the one or more setting(s) 202 such that TTR may be maintained within TI.

It should be noted that a range of modification of the one or more setting(s) 202 may be limited. If this is the case, processor 108 may be able to modify the one or more setting(s) 202 until limits of the range of modification are reached. Further, it should be noted that the abovementioned capturing of the one or more settings(s) 202 may be performed through processor 108 in conjunction with operating system 112. In one example embodiment, processor 108 may generate timestamps associated with the rendering process for each video frame 116_{1-N}. Here, processor 108 may calculate TTR based on the aforementioned timestamps. Other implementations are within the scope of the exemplary embodiments discussed herein.

The discussion above has been specifically directed to maintaining frame rate 204 through modifying the one or more setting(s) 202; the aforementioned one or more setting(s) 202 may be associated with visual quality of the gaming experience. However, it should be noted that the modification of any parameter at the expense of another may be within the scope of the exemplary embodiments. A game locally played at client device 104 (in other words, a single-player game) may not require quick responses on part of user 150. For example, user 150 may play an Android® based game such as Ant Smasher where he/she is merely required to squash ants travelling between an origin and a destination. User 150 may have to squash the ants before they reach the destination. In this case, visual quality may be preferable to frame rate 204 as clicking on a honeybee instead of an ant would end the game.

To summarize, exemplary embodiments may provide for a trade-off between one or more parameter(s) related to visual quality associated with the gaming experience and one or more parameter(s) related to latency associated with video frame/graphics rendering (e.g., frame rate 204 or other parameters). Further, it should be noted that exemplary embodiments may not be restricted to gaming scenarios. Other scenarios involving video-viewing and/or graphics visualization are within the scope of the exemplary embodiments.

In the case of solutions such as NVIDIA®'s GPU Boost™, frame rate 204 may be improved through boosting GPU clocks (or, clocking the GPU (example processor 108) at higher rates) based on available thermal/power headroom. Here, more power may be consumed in increasing frame rate 204. In contrast, exemplary embodiments provide for increased frame rate 204 (and other parameters) without increasing power consumption. In some cases, the power consumption through client device 104 may be reduced. Also, it is obvious that the automation of the capturing and the maintenance processes discussed above provides for a focused, distraction-free gaming/video-viewing experience to user 150.

It should be noted that instructions associated with driver component 302, the abovementioned capturing of TTR/frame rate 204 (and/or other parameters) and/or the maintenance of frame rate 204 (and/or other parameters) within bounds may be embodied in a non-transitory medium (e.g., Compact Disc (CD), Digital Video Disc (DVD), Blu-ray Disc®, hard drive) readable through client device 104 (a data processing device) and executable therethrough. Further, driver component 302 may be provided packaged with multimedia application 114 and/or operating system 112 executing on client device 104. Still further, driver component 302 may trigger the capturing and/or the maintenance processes discussed above upon user 150 launching multimedia application 114 on client device 104. All reasonable variations are within the scope of the exemplary embodiments discussed herein.

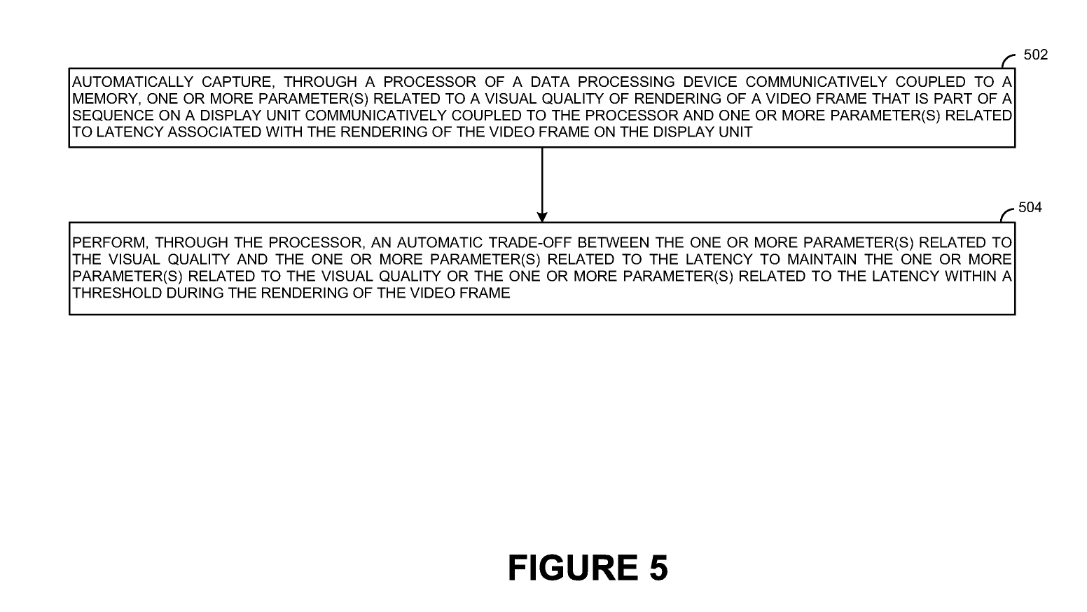

FIG. 5 shows a process flow diagram detailing the operations involved in automatically performing a trade-off between visual quality and latency during rendering of a video/graphics sequence, according to one or more embodiments. In one or more embodiments, operation 502 may involve automatically capturing, through processor 108, one or more parameter(s) related to a visual quality of rendering of video frame 116_{1-N} that is part of a sequence on display unit 120 and one or more parameter(s) related to latency associated with the rendering of video frame 116_{1-N} on display unit 120. In one or more embodiments, the sequence may be a video sequence and/or a graphics sequence. In one or more embodiments, operation 504 may then involve performing, through processor 108, an automatic trade-off between the one or more parameter(s) related to the visual quality and the one or more parameter(s) related to the latency to maintain the one or more parameter(s) related to the visual quality or the one or more parameter(s) related to the latency within a threshold during the rendering of video frame 116_{1-N}.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a data processing device such as client device 104). Accordingly, the specification and drawings are to be regarded in an illustrative rather than a restrictive sense.

What is claimed is:

1. A method comprising:
automatically capturing, through a processor of a data processing device communicatively coupled to a memory, at least one parameter related to a visual quality of rendering of a video frame that is part of a sequence on a display unit communicatively coupled to the processor and at least one parameter related to latency associated with the rendering of the video frame on the display unit, the sequence being at least one of: a video sequence and a graphics sequence; and
performing, through the processor, an automatic trade-off between the at least one parameter related to the visual quality and the at least one parameter related to the latency to maintain one of: the at least one parameter related to the visual quality and the at least one parameter related to the latency within a threshold during the rendering of the video frame.

2. The method of claim 1, further comprising triggering at least one of: the automatic capturing of the at least one parameter related to the visual quality and the at least one parameter related to the latency and the automatic trade-off between the at least one parameter related to the visual quality and the at least one parameter related to the latency through a driver component associated with the processor.

3. The method of claim 1, comprising automatically capturing the at least one parameter related to the visual quality and the at least one parameter related to the latency through the processor in conjunction with an operating system executing on the data processing device.

4. The method of claim 2, comprising at least one of:
providing the driver component packaged with at least one of: an operating system and an application executing on the data processing device; and
performing, through the processor, the automatic capturing and the automatic trade-off during the execution of the application, the video frame being rendered as part of the execution of the application.

5. The method of claim 1, comprising automatically modifying, through the processor, the at least one parameter related to the visual quality of the rendering of the video frame to maintain a frame rate of the rendering of the video frame on the display unit.

6. The method of claim 5, further comprising:
capturing, through the processor, a time taken to render the video frame on the display unit;
determining, through the processor, if the time taken to render the video frame is greater than an expected time therefor; and
automatically modifying, through the processor, the at least one parameter related to the visual quality of the rendering if the time taken to render the video frame is determined to be greater than the expected time to maintain the time taken to render the video frame within the expected time, thereby maintaining the frame rate of the rendering.

7. The method of claim 2, further comprising launching an application on the data processing device to trigger the at least one of: the automatic capturing of the at least one parameter related to the visual quality and the at least one parameter related to the latency and the automatic trade-off between the at least one parameter related to the visual quality and the at least one parameter related to the latency through the driver component.

8. A non-transitory medium, readable through a data processing device and comprising instructions embodied therein that are executable through the data processing device, comprising:
instructions to automatically capture, through a processor of the data processing device communicatively coupled to a memory, at least one parameter related to a visual quality of rendering of a video frame that is part of a sequence on a display unit communicatively coupled to the processor and at least one parameter related to latency associated with the rendering of the video frame on the display unit, the sequence being at least one of: a video sequence and a graphics sequence; and
instructions to perform, through the processor, an automatic trade-off between the at least one parameter related to the visual quality and the at least one parameter related to the latency to maintain one of: the at least one parameter related to the visual quality and the at least one parameter related to the latency within a threshold during the rendering of the video frame.

9. The non-transitory medium of claim 8, further comprising instructions to trigger at least one of: the automatic capturing of the at least one parameter related to the visual quality and the at least one parameter related to the latency and the automatic trade-off between the at least one parameter related to the visual quality and the at least one parameter related to the latency through a driver component associated with the processor.

10. The non-transitory medium of claim 8, comprising instructions to automatically capture the at least one parameter related to the visual quality and the at least one parameter related to the latency through the processor in conjunction with an operating system executing on the data processing device.

11. The non-transitory medium of claim 8, comprising:
instructions to perform, through the processor, the automatic capturing and the automatic trade-off during execution of an application on the data processing device, the video frame being rendered as part of the execution of the application.

12. The non-transitory medium of claim 8, comprising instructions to automatically modify, through the processor, the at least one parameter related to the visual quality of the rendering of the video frame to maintain a frame rate of the rendering of the video frame on the display unit.

13. The non-transitory medium of claim 12, further comprising:
instructions to capture, through the processor, a time taken to render the video frame on the display unit;
instructions to determine, through the processor, if the time taken to render the video frame is greater than an expected time therefor; and
instructions to automatically modify, through the processor, the at least one parameter related to the visual quality of the rendering if the time taken to render the video frame is determined to be greater than the expected time to maintain the time taken to render the video frame within the expected time, thereby maintaining the frame rate of the rendering.

14. A data processing device comprising:
a memory; and
a processor communicatively coupled to the memory, the processor being configured to execute instructions to:
automatically capture at least one parameter related to a visual quality of rendering of a video frame that is part of a sequence on a display unit communicatively coupled to the processor and at least one parameter related to latency associated with the rendering of the video frame on the display unit, the sequence being at least one of: a video sequence and a graphics sequence, and
perform an automatic trade-off between the at least one parameter related to the visual quality and the at least one parameter related to the latency to maintain one of: the at least one parameter related to the visual quality and the at least one parameter related to the latency within a threshold during the rendering of the video frame.

15. The data processing device of claim 14, further comprising a driver component associated with the processor to trigger at least one of: the automatic capturing of the at least one parameter related to the visual quality and the at least one parameter related to the latency and the automatic trade-off between the at least one parameter related to the visual quality and the at least one parameter related to the latency.

16. The data processing device of claim 14, wherein the processor is configured to execute instructions to automatically capture the at least one parameter related to the visual quality and the at least one parameter related to the latency in conjunction with an operating system executing on the data processing device.

17. The data processing device of claim 15, wherein at least one of:
the driver component is provided packaged with at least one of: an operating system and an application executing on the data processing device, and
the processor is configured to execute instructions to perform the automatic capturing and the automatic trade-off during the execution of the application, the video frame being rendered as part of the execution of the application.

18. The data processing device of claim 14, wherein the processor is configured to execute instructions to automatically modify the at least one parameter related to the visual quality of the rendering of the video frame to maintain a frame rate of the rendering of the video frame on the display unit.

19. The data processing device of claim 15, wherein the processor is further configured to execute instructions to:
capture a time taken to render the video frame on the display unit,
determine if the time taken to render the video frame is greater than an expected time therefor, and
automatically modify the at least one parameter related to the visual quality of the rendering if the time taken to render the video frame is determined to be greater than the expected time to maintain the time taken to render the video frame within the expected time, thereby maintaining the frame rate of the rendering.

20. The data processing device of claim 15, wherein launching an application on the data processing device is configured to trigger the at least one of: the automatic capturing of the at least one parameter related to the visual quality and the at least one parameter related to the latency and the automatic trade-off between the at least one parameter related to the visual quality and the at least one parameter related to the latency through the driver component.
